(19) United States
(12) Patent Application Publication
(10) Pub. No.: US 2021/0153630 A1
(43) Pub. Date: May 27, 2021

(54) MUG WITH ROTATABLE CARABINER-STYLE HANDLE

(71) Applicant: Hongyuan Han, New Vernon, NJ (US)

(72) Inventor: Hongyuan Han, New Vernon, NJ (US)

(21) Appl. No.: 16/953,802

(22) Filed: Nov. 20, 2020

Related U.S. Application Data
(60) Provisional application No. 62/939,259, filed on Nov. 22, 2019.

(51) Int. Cl. A45F 3/18; A47G 19/22; F16B 45/00

(52) U.S. Cl. CPC A45F 3/18; F16B 45/00; A47G 19/2255

(57) ABSTRACT

Various beverage containers are described. One such beverage container includes a cup; a first hinge portion, attached to the cup and defining a lower track edge; and a second hinge, portion attached to the cup and defining an upper track edge. The beverage container includes also includes a rotatable handle. The lower track edge and the upper track edge define a track which is configured to retain the rotatable handle in a first position.

### STATEMENT REGARDING FEDERALLY SPONSORED RESEARCH OR DEVELOPMENT

N/A

### BACKGROUND OF THE INVENTION

Various embodiments relate generally to containers with handles and, more specifically, relate to mugs with a rotatable handle.

This section is intended to provide a background or context. The description may include concepts that may be pursued, but have not necessarily been previously conceived or pursued. Unless indicated otherwise, what is described in this section is not deemed prior art to the description and claims and is not admitted to be prior art by inclusion in this section.

When traveling, e.g., hiking or camping, it may be difficult to pack all items easily. Certain items, such as cups and mugs present an additional problem due to the presence of a handle which makes it more convenient for use, but less easily stored.

What is need is an easy to use beverage container that can be packed or carried easily.

### BRIEF SUMMARY OF THE INVENTION

The below summary is merely representative and non-limiting.

The above problems are overcome, and other advantages may be realized, by the use of the embodiments.

In a first aspect, an embodiment provides a beverage container. The beverage container includes a cup; a first hinge portion, attached to the cup and defining a lower track edge; and a second hinge, portion attached to the cup and defining an upper track edge. The beverage container includes also includes a rotatable handle. The lower track edge and the upper track edge define a track which is configured to retain the rotatable handle in a first position.

### BRIEF DESCRIPTION OF THE SEVERAL VIEWS OF THE DRAWINGS

Aspects of the described embodiments are more evident in the following description, when read in conjunction with the attached Figures.

FIG. 1 is a perspective view of a mug according to the present invention wherein the carabiner-style handle is turned outward from the surface of the mug.

FIG. 2 is another perspective view of the mug of FIG. 1, wherein the carabiner-style handle is turned to the side.

FIG. 3 is a side view of the mug of FIG. 1 wherein the carabiner-style handle is turned outward.

FIG. 4 is a front view of the mug of FIG. 1 wherein the carabiner-style handle is turned outward.

FIG. 5 is a bottom view of the mug of FIG. 1 wherein the carabiner-style handle is turned outward.

FIG. 6 is a view of the mug of FIG. 1 showing the various components.

### DETAILED DESCRIPTION OF THE INVENTION

This patent application claims priority from U.S. Provisional Patent Application No. 62/939,259, filed Nov. 22, 2019, the disclosure of which is incorporated by reference herein in its entirety.

Various embodiment provide a beverage container, such as a cup or mug, that can be packed or carried easily. Such containers provide an easy-to-use handle which can be folded to the side for storage. In addition, the handle may be a carabiner-style handle which may be used to hang the mug, for example, from a backpack.

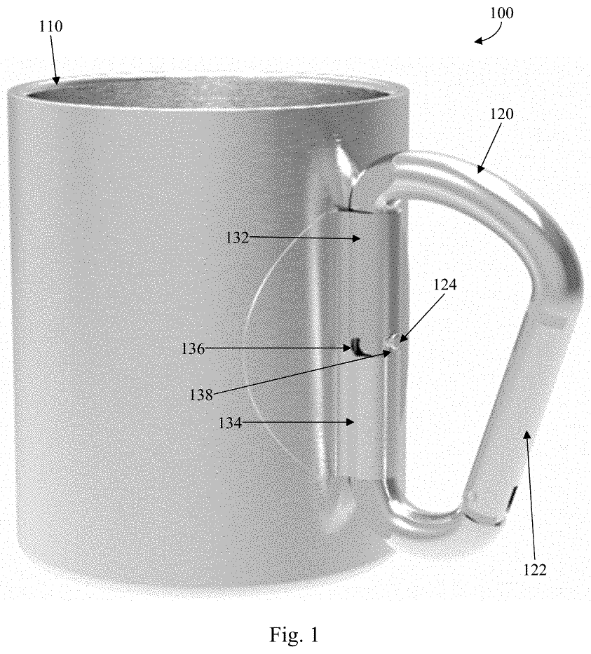

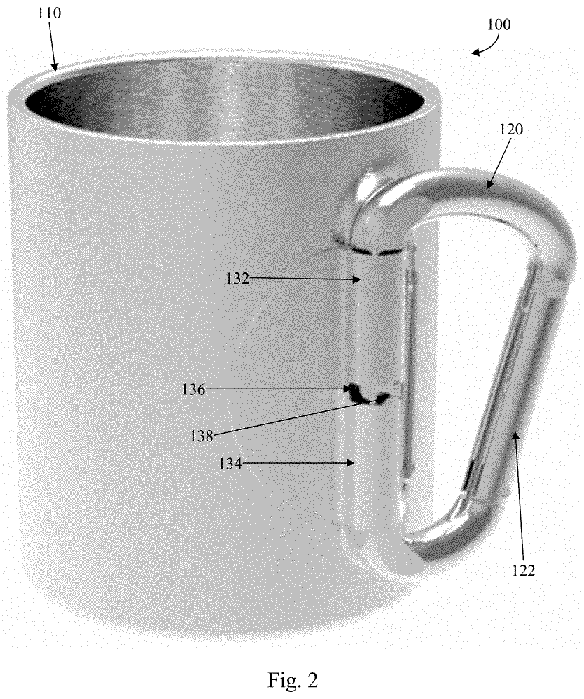

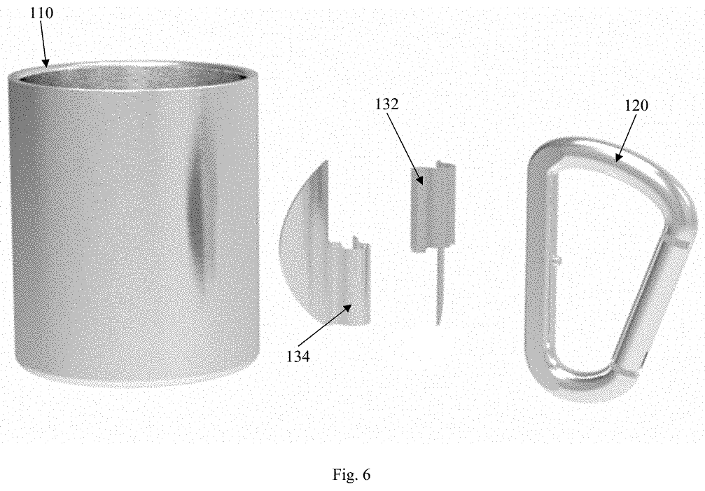

FIG. 1 is a perspective view of a mug 100 according to an embodiment wherein the carabiner-style handle 120 is turned outward from the surface of the cup 110 and FIG. 2 is another perspective view of the mug 100 of FIG. 1, wherein the carabiner-style handle 120 is turned to the side. The carabiner 120, as shown separately in FIG. 6, includes an inwardly facing post 124. This post 124 interacts with the track 136 created between the upper hinge 132 and lower hinge 134 so as to retain the handle 120 in the outwardly facing position. As shown, the track 136 includes a structure 138 to hold the post 124.

One purpose of the rotating handle 120 is to save space when camper/hiker packs the mug 100 in their bags. Once the carabiner-style handle 120 is rotated into place for drinking out of the cup 110, the handle 120 is locked into position. Additional force can be used to rotate the handle 120 back to the folded or closed position. The carabiner-style handle 120 allows the user to hang the mug when not in use with the traditional carabiner function using the spring-loaded gate 122. In further embodiments the gate on the handle may be secured by a screw-lock, a twist-lock, magnets, etc. These structures may be in addition to or as an alternative to spring-loaded features in the gate.

In further embodiments, the track 136 may include additional structures to support positions in which to secure the handle, for example, to hold the handle against the side of the mug.

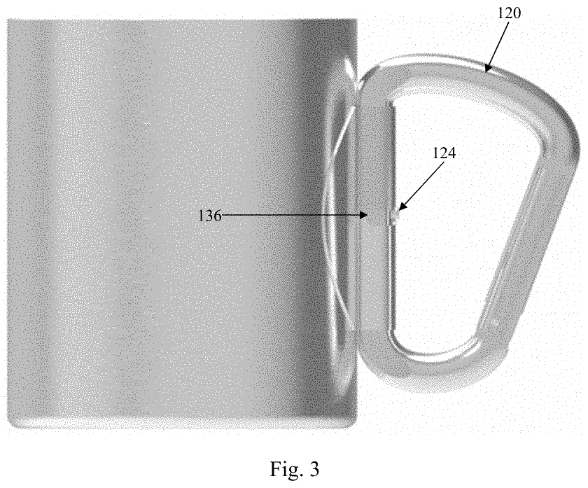

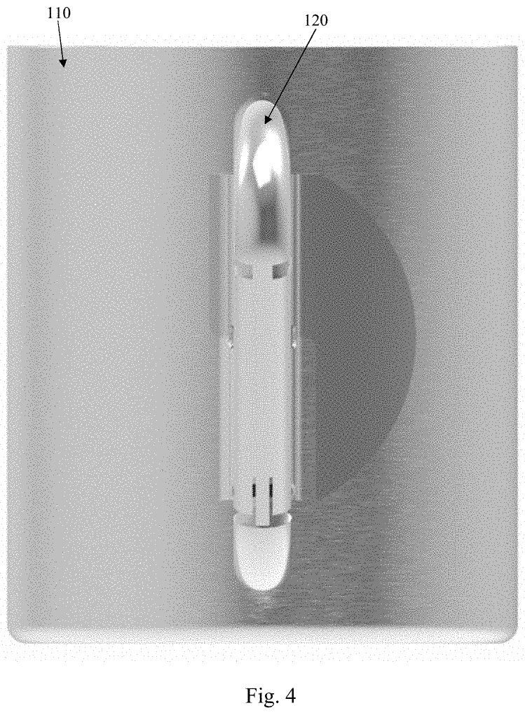

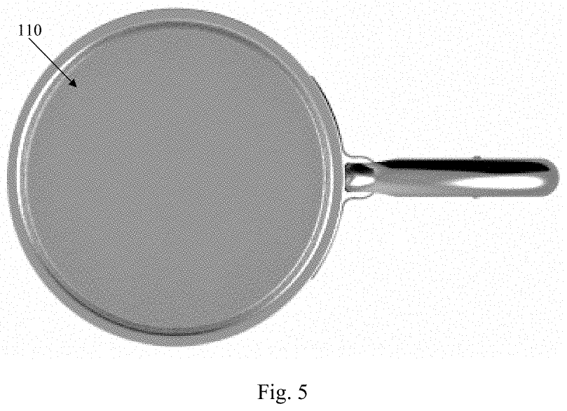

FIG. 3 is a side view of the mug 100 of FIG. 1 wherein the carabiner-style handle 120 is turned outward. FIG. 4 is a front view of the mug of FIG. 1 wherein the carabiner-style handle 120 is turned outward. FIG. 5 is a bottom view of the mug of FIG. 1 wherein the carabiner-style handle 120 is turned outward.

FIG. 6 is a view of the mug of FIG. 1 showing the various components. The mug 100 is shown as a cylindrical container or cup 110. In alternative embodiments, the mug may be substantially cylindrical, partially conic, and/or include flat sides (e.g., hexagonal).

The mug 100 may be of any size, although sizes ranging between 6 oz to 20 oz may be more preferred for beverages.

The mug 100 may be single walled or double walled. If double walled, the mug can be vacuum sealed or non-vacuum sealed.

The cup 110, hinges 132, 134 and handle 120 can be made of any appropriate material, for example, copper, aluminum, stainless steel, plastic, etc. In some non-limiting embodiments, the elements may be of different materials, for example, the upper hinge 132 may be made of copper while the lower hinge 134 is made of aluminum; the cup 110 and hinges 132, 134 may be made of plastic and the handle 120 made of aluminum; etc.

In further embodiments, one or both hinge portions 132, 134 may be incorporated into the cup portion 110. In other embodiments, the hinge portions 132, 134 may be affixed to the cup portions 110, for example, welded, glued, etc.

The foregoing description has been directed to particular embodiments. However, other variations and modifications may be made to the described embodiments, with the attainment of some or all of their advantages. Modifications to the above-described systems and methods may be made without departing from the concepts disclosed herein. Accordingly, the invention should not be viewed as limited by the disclosed embodiments. Furthermore, various features of the described embodiments may be used without the corresponding use of other features. Thus, this description should be read as merely illustrative of various principles, and not in limitation of the invention.

What is claimed is:

1. A beverage container comprising:
a cup;
a first hinge portion attached to the cup and defining a lower track edge;
a second hinge portion attached to the cup and defining an upper track edge; and
a rotatable handle,
wherein the lower track edge and the upper track edge define a track which is configured to retain the rotatable handle in a first position.

2. The beverage container of claim 1, wherein the cup is at least one of: copper, aluminum, stainless steel, plastic, wood and ceramic.

3. The beverage container of claim 1, wherein the first hinge portion is at least one of:
copper, aluminum, stainless steel, plastic, wood and ceramic.

4. The beverage container of claim 1, wherein the second hinge portion is at least one of:
copper, aluminum, stainless steel, plastic, wood and ceramic.

5. The beverage container of claim 1, wherein the rotatable handle is at least one of: copper, aluminum, stainless steel, plastic, wood and ceramic.

6. The beverage container of claim 1, wherein the rotatable handle is a carabiner-style handle.

7. The beverage container of claim 6, wherein the rotatable handle comprises a spring-loaded gate.

8. The beverage container of claim 1, wherein the cup is cylindrical.

9. The beverage container of claim 1, wherein the first position is radially outward from the cup.

10. The beverage container of claim 1, wherein the rotatable handle comprises a post.

11. The beverage container of claim 10, wherein the track is configured to retain the rotatable handle in a first position by engaging the post.

12. The beverage container of claim 1, wherein the track comprises a retaining structure configured to retain the rotatable handle in the first position.

13. The beverage container of claim 1, wherein the track is further configured to retain the rotatable handle in a second position.

14. The beverage container of claim 1, wherein the cup is one of: single-walled or double-walled.
